(19) United States
(12) Patent Application Publication
(10) Pub. No.: US 2024/0318012 A1
(43) Pub. Date: Sep. 26, 2024

(54) OXIDATION PROTECTIVE SYSTEMS AND METHODS OF MANUFACTURE

(71) Applicant: GOODRICH CORPORATION, Charlotte, NC (US)

(72) Inventors: ZHONGFEN DING, South Windsor, CT (US); Kevin R. Bordage, Westfield, MA (US); Steven Poteet, Lake Forest, CA (US)

(73) Assignee: GOODRICH CORPORATION, Charlotte, NC (US)

(21) Appl. No.: 18/186,821

(22) Filed: Mar. 20, 2023

(51) Int. Cl. C09D 7/48; C09D 1/00; C09D 7/40; C09D 7/61; C09D 185/00

(52) U.S. Cl. CPC C09D 7/48; C09D 1/00; C09D 7/61; C09D 7/68; C09D 185/00; C08K 3/105; C08K 3/11; C08K 2201/003; C08K 2201/012

(57) ABSTRACT

A method for forming an oxidation protection system on a carbon-carbon composite structure comprises applying a silicone-based slurry to the carbon-carbon composite structure, the silicone-based slurry including metal pigments disposed therein; applying a sealing slurry to the silicone-based slurry; and heating the carbon-carbon composite structure.

### FIELD

The present disclosure relates generally to composites and, more specifically, to oxidation protection systems for carbon-carbon composite structures.

### BACKGROUND

Oxidation protection systems for carbon-carbon composites are typically designed to minimize loss of carbon material due to oxidation at high temperature operating conditions, which include temperatures of 427° C. (800° F.) or greater. Carbon-carbon composites have high specific strength, ranging from low to very high temperatures. However, carbon-carbon composites are intrinsically prone to oxidation in ambient environment to form carbon monoxide and carbon dioxide gases, losing mass and strength. Oxidation protection system (OPS) facilitate increased life cycles for carbon-carbon composite components, especially when used at high temperature applications.

OPS coatings to protect C/C composite from oxidation damage through forming a barrier to block oxygen diffusion into the C/C substrate, in addition, oxygen gettering phase is also incorporated in the coating structure to remove O₂ molecules that diffused into the coating through fine cracks and defects.

### SUMMARY

A method for forming an oxidation protection system on a carbon-carbon composite structure is disclosed herein. In various embodiments, the method comprises applying a silicone-based slurry to the carbon-carbon composite structure, the silicone-based slurry including metal pigments disposed therein; applying a sealing slurry to the silicone-based slurry; and heating the carbon-carbon composite structure.

In various embodiments, the sealing slurry comprises a silicon compound, a glass mixture, a glass former, a glass modifier, and a carrier fluid. In various embodiments, the glass mixture including a first glass compound and a second glass compound, the first glass compound having a first viscosity-temperature profile that is at least two orders of magnitude below a second viscosity-temperature profile of the second glass compound.

In various embodiments, the metal pigments include at least one of aluminum, silicon, chromium, iron, copper, nickel, silver, and gold. In various embodiments, the metal pigments include at least one of aluminum and silicon.

In various embodiments, the metal pigments are between 1% and 20% by weight of the silicone-based slurry.

In various embodiments, the metal pigments include a median diameter range between 0.5 μm and 70 μm.

In various embodiments, the metal pigments are leafing pigments, and wherein in response to solvents in the silicone-based slurry evaporating, convection currents push the metal pigments to a surface of a silicone-based coating formed from the silicone-based slurry from the heating of the carbon-carbon composite structure.

In various embodiments, the metal pigments are non-leafing pigments, and wherein in response to the heating of the carbon-carbon composite structure, the non-leafing pigments are distributed throughout a silicone-based coating formed from the silicone-based slurry.

A carbon-carbon composite component is disclosed herein. In various embodiments, the carbon-carbon composite component comprises a composite structure; an oxidation protection system disposed on the composite structure, the oxidation protection system including: a primary layer coupled to the composite structure, the primary layer including a silicone-based coating with metal pigments, and a sealing layer coupled to the primary layer, the sealing layer configured to penetrate a microporous framework of the primary layer.

In various embodiments, the metal pigments comprise leafing metal pigments. In various embodiments, the leafing metal pigments form a leafing layer between the primary layer and the sealing layer.

In various embodiments, the metal pigments comprise non-leafing metal pigments distributed throughout the silicone-based coating.

In various embodiments, the metal pigments include a median diameter range between 0.5 μm and 70 μm.

In various embodiments, the metal pigments are between 1% and 20% by weight of the silicone-based coating.

In various embodiments, the metal pigments comprise at least one of aluminum, silicon, chromium, iron, copper, nickel, silver, and gold.

An oxidation protection system for a carbon-carbon composite structure is disclosed herein. In various embodiments, the oxidation protection system comprising a silicone-based coating configured to couple to the carbon-carbon composite structure, the silicone-based coating including metal pigments, and a sealing layer configured to couple to the silicone-based coating, the sealing layer configured to penetrate a microporous framework formed from the silicone-based coating, the sealing layer formed from a glass mixture including a first glass compound and a second glass compound, the first glass compound having a first viscosity-temperature profile that is at least two orders of magnitude below a second viscosity-temperature profile of the second glass compound.

In various embodiments, the metal pigments are leafing metal pigments, and wherein, the leafing metal pigments form a leafing layer between the silicone-based coating and the sealing layer.

In various embodiments, the metal pigments are non-leafing metal pigments, and wherein the metal pigments are distributed throughout the silicone-based coating.

In various embodiments, the metal pigments comprise at least one of aluminum, silicon, chromium, iron, copper, nickel, silver, and gold.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a cross sectional view of an aircraft wheel brake assembly, in accordance with various embodiments;

FIG. 2 illustrates a carbon-carbon composite structure with an oxidation protection system, in accordance with various embodiments;

FIG. 3A illustrates a carbon-carbon composite structure with an oxidation protection system, in accordance with various embodiments;

FIG. 3B illustrates a carbon-carbon composite structure with an oxidation protection system, in accordance with various embodiments;

FIG. 4 illustrates a method for forming an oxidation protection system on a composite structure, in accordance with various embodiments;

FIG. 5A illustrates a viscosity-temperature profile for a glass compound in a glass mixture of a sealing layer of an oxidation protection system, in accordance with various embodiments;

FIG. 5B illustrates a viscosity-temperature profile for a glass compound in a glass mixture of a sealing layer of an oxidation protection system, in accordance with various embodiments; and

FIG. 5C illustrates a viscosity-temperature profile for a glass compound in a glass mixture of a sealing layer of an oxidation protection system, in accordance with various embodiments.

### DETAILED DESCRIPTION

The detailed description of embodiments herein makes reference to the accompanying drawings, which show embodiments by way of illustration. While these embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not for limitation. For example, any reference to singular includes plural embodiments, and any reference to more than one component or step may include a singular embodiment or step. Also, any reference to attached, fixed, connected or the like may include permanent, removable, temporary, partial, full and/or any other possible attachment option.

Disclosed herein is an advanced OPS that utilizes a silicone-based coating as a building block for oxidation protection of a carbon-carbon composite component.

The advanced OPS is composed of multiple layers, with a thin barrier layer that can bond well with C/C composite substrate. Silicone-based coating loaded with metal particles (e.g., aluminum and/or silicon) can be sprayed on to form a homogeneous layer. The coating can then bake in an inert atmosphere to form a microporous framework. The thin layer with homogeneous thickness then can hold a thin glass layer that can effectively seal the coating structure.

In various embodiments, a sealing layer can be formed on the silicone-based coating. The sealing layer can be one or a combination of phosphate glass, alkaline glass, borosilicate glass, SiO₂, SiOC, SiON glass, and high temperature glass, depending on the temperature range of the C/C composite components operate. The glass layer can provide a seal for the microporous silica framework, which sits on a thin barrier layer on the glass.

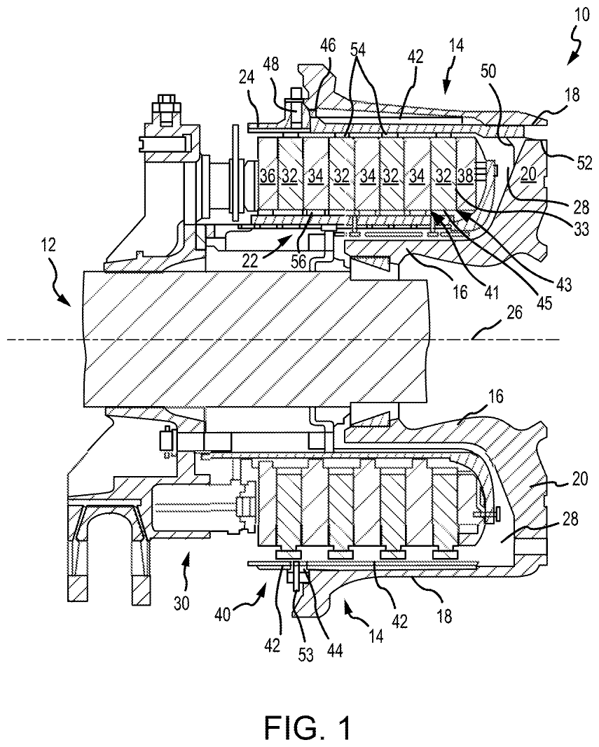

With initial reference to FIG. 1, aircraft wheel brake assembly 10 such as may be found on an aircraft, in accordance with various embodiments is illustrated. Aircraft wheel brake assembly may, for example, comprise a bogie axle 12, a wheel including a hub 16 and a wheel well 18, a web 20, a torque take-out assembly 22, one or more torque bars 24, a wheel rotational axis 26, a wheel well recess 28, an actuator 30, multiple brake rotors 32, multiple brake stators 34, a pressure plate 36, an end plate 38, a heat shield 40, multiple heat shield sections 42, multiple heat shield carriers 44, an air gap 46, multiple torque bar bolts 48, a torque bar pin 50, a wheel web hole 52, multiple heat shield fasteners 53, multiple rotor lugs 54, and multiple stator slots 56.

Brake disks (e.g., interleaved rotors 32 and stators 34) are disposed in wheel well recess 28 of wheel well 18. Rotors 32 are secured to torque bars 24 for rotation with wheel 14, while stators 34 are engaged with torque take-out assembly 22. At least one actuator 30 is operable to compress interleaved rotors 32 and stators 34 for stopping the aircraft. In this example, actuator 30 is shown as a hydraulically actuated piston, but many types of actuators are suitable, such as an electromechanical actuator. Pressure plate 36 and end plate 38 are disposed at opposite axial ends of the interleaved rotors 32 and stators 34. Rotors 32 and stators 34 can comprise any material suitable for friction disks, including ceramics or carbon materials, such as a carbon/carbon composite.

Through compression of interleaved rotors 32 and stators 34 between pressure plates 36 and end plate 38, the resulting frictional contact slows rotation of wheel 14. Torque take-out assembly 22 is secured to a stationary portion of the landing gear truck such as a bogie beam or other landing gear strut, such that torque take-out assembly 22 and stators 34 are prevented from rotating during braking of the aircraft.

The friction disks (e.g., rotors 32, stators 34, pressure plate 36, end plate 38) may be formed of carbon-carbon (C/C) composites having carbon fibers disposed in a carbon matrix). The C/C composites may operate as heat sinks to absorb large amounts of kinetic energy converted to heat during slowing of the aircraft. Heat shield 40 may reflect thermal energy away from wheel well 18 and back toward rotors 32 and stators 34.

In various embodiments, brake disks of aircraft wheel brake assembly 10 may reach operating temperatures in the range from about 100° C. (212° F.) up to about 900° C. (1652° F.), or higher (e.g., 1093° C. (2000° F.)). The high temperatures experienced by aircraft wheel brake assembly 10 can lead to loss of C/C composite material due to oxidation of carbon. For example, various C/C composite components of aircraft wheel brake assembly 10 may experience both catalytic oxidation and inherent thermal oxidation caused by heating the composite during operation. In various embodiments, rotors 32 and stators 34 may be heated to sufficiently high temperatures that may oxidize the carbon surfaces exposed to air. At elevated temperatures, infiltration of air and contaminants may cause internal oxidation and weakening, especially in and around brake rotor lugs 54 or stator slots 56 securing the friction disks to the respective torque bar 24 and torque take-out assembly 22. Because C/C composite components of aircraft wheel brake assembly 10 may retain heat for a substantial time period after slowing the aircraft, oxygen from the ambient atmosphere may react with the carbon matrix and/or carbon fibers to accelerate material loss. Further, damage to brake components may be caused by the oxidation enlargement of cracks around fibers or enlargement of cracks in a reaction-formed porous barrier coating (e.g., a silicon-based barrier coating) applied to the C/C composite.

Elements identified in severely oxidized regions of C/C composite brake components include potassium (K) and sodium (Na). These alkali contaminants may come into contact with aircraft brakes as part of cleaning or de-icing materials. Other sources include salt deposits left from seawater or sea spray. These and other contaminants (e.g., Ca, Fe, etc.) can penetrate and leave deposits in pores of C/C composite aircraft brakes, including the substrate and any reaction-formed porous barrier coating. When such contamination occurs, the rate of carbon loss by oxidation can be increased by one to two orders of magnitude.

In various embodiments, an oxidation protection system, as disclosed herein, may be applied to the various components of aircraft wheel brake assembly 10 for protecting the components from oxidation. However, it will be recognized that the oxidation protection systems and methods of forming the same, as disclosed herein, may be readily adapted to many parts in this and other brake assemblies, as well as to other C/C composite structures susceptible to oxidation losses from infiltration of atmospheric oxygen and/or catalytic contaminants.

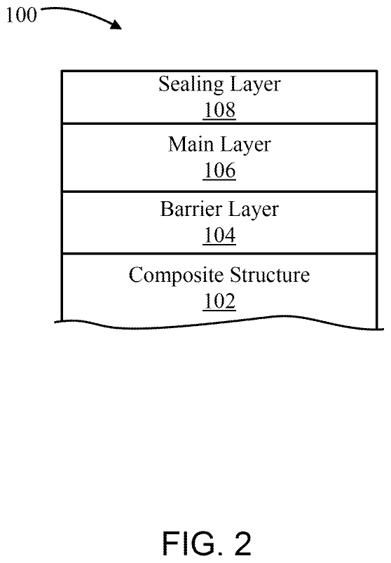

Referring now to FIG. 2, an oxidation protection system 100 for protecting a C/C composite structure (e.g., composite structure 102) is illustrated, in accordance with various embodiments. In various embodiments, the oxidation protection system comprises a barrier layer 104, a primary layer 106 and a sealing layer 108. In various embodiments, the barrier layer 104 can facilitate adhesion between the composite structure 102 and the primary layer 106. In various embodiments, the barrier layer 104 can be omitted. In various embodiments, as described further herein, the primary layer 106 is a silicone-based coating that is loaded with metal particles (e.g., alumina particles, silica particles, or the like). In various embodiments, the primary layer 106 can be sprayed on to form a homogeneous layer. A “homogenous layer” as described herein is relative to typical coatings of oxidation protection systems. Stated another way, the primary layer 106 is more homogeneous compared to typical a boron-formed layer of oxidation protection system (e.g., oxidation protection systems that include a boron compound, a glass compound, a glass former compound, a glass modifier, and a carrier fluid). In various embodiments, the silicone-based coating can then be baked in an inert atmosphere to form a microporous framework. In various embodiments, the primary layer 106 can be a thin layer with uniform thickness. In various embodiments, by having a more homogeneous layer relative to typical oxidation protection systems, the primary layer 106 can be thinner and lighter relative to typical primary layers of oxidation protection systems, in accordance with various embodiments. The sealing layer 108 can then be held by the primary layer 106 and effectively seal the silicone-based coating, as described further herein.

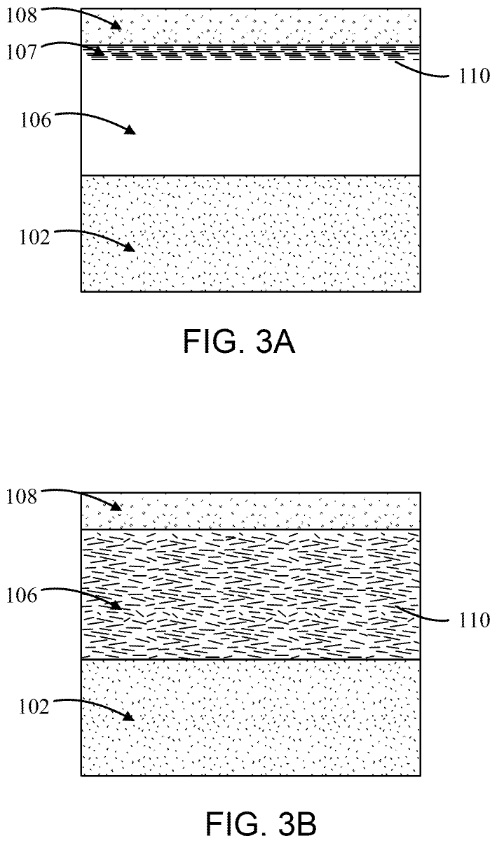

In various embodiments, the primary layer 106 can include pigments 110 (e.g., either leafing pigments (as shown in FIG. 3A) or non-leafing pigments (as shown in FIG. 3B)). In various embodiments, leafing pigments can be ball milled with a lubricant (i.e., stearic acid), which produces a pigment with high interfacial tension. The interfacial tension can prevent the binders (i.e., silicone resin) or solvent (i.e., water or other solvent) from wetting the pigment surface. As the solvents within the primary layer 106 (i.e., the silicone-based coating) evaporates, convection currents push the pigments to the surface of the primary layer 106. Since leafing pigments are coated such that they prevent their surfaces from being wetted (by resin and solvents within the system) they remain atop the surface of the coating as shown in FIG. 3A. This creates a dense scale-like layer at the surface of the coating. Therefore, with leafing pigments, another barrier can be created between the primary layer 106 and the sealing layer 108 (e.g., leafing layer 107 as shown in FIG. 3A). As the overlapping pigments create a pseudo-layer preventing oxidation, in accordance with various embodiments. In this regard, the overlapping pigments can create a pseudo sealing layer between the primary layer 106 and the sealing layer 108.

Conversely, in accordance with various embodiments, non-leafing pigments can be milled in materials that enable the pigment to be readily wetted by the solvents and resins within the primary layer (e.g., the silicone-based coating). This enables the pigments to be distributed homogenously in the coating matrix and after baking create a microporous framework which can subsequently be sealed (e.g., by the sealing layer 108).

In various embodiments, the pigments 110 of FIGS. 3A and 3B can include a median diameter between 0.5 and 70 μm, or between 5 and 40 μm, or between 8 and 18 μm. The pigment 110 generally has a laminar structure and functions to form a barrier from corrosive elements thereby protecting the composite structure 102 and serves to improve coating properties. Filler materials, as disclosed herein, can include pigments in the form of a paste containing flake metal. These pigments react with O₂ that diffuses into the barrier layer through any defects or fine cracks of the coating system to form oxide and thus serving as oxygen getter. The reaction formed oxides fill the micropores of the barrier layer. These pigments in addition to functioning as a barrier from corrosive elements and improving coating properties also impart color to the coating composition. Embodiments herein can utilize a VOC-free, aluminum-based metallic pigment. An example is produced by Shlenk and is commercially called Aquasilber LPW/2140.

In various embodiments, the pigments 110 disclosed herein can be any of the following metals/metalloids and their alloys/oxidated forms: aluminum containing compounds (e.g., aluminum, alumina, etc.), silicon containing compounds (i.e., silica, silicon, etc.)), chromium, iron and alloys thereof (i.e., stainless steel), copper and alloys thereof (i.e., bronze), nickel, silver, gold, etc. In various embodiments, the pigments 110 include aluminum and/or silicon.

In various embodiments, the pigments 110 comprise between 1% and 20% of the silicone-based coating by weight, or approximately 10%±2% by weight of the silicone-based coating.

In various embodiments, the primary layer 106 can be formed such that it includes silicone resin emulsion, a metal pigment 110 (e.g., leafing or non-leafing), a water soluble ionic surfactant, and water.

The emulsion functions as a high heat resistant binder for the pigment element and generally will have a total silicone resin solids content of approximately 38% to 82% by weight. The silicone resin emulsion is comprised of 100 parts by weight of (i) at least one silicone resin having one or more organic side groups attached such as phenyl, methyl, trifluoropropyl and/or vinyl moieties; (ii) an anionic surfactant effective for dispersing the resin in a water based emulsion and for binding the resin or particulate phase and the water or continuous phase; and (iii) an amount of water effective for providing a preselected silicone resin solids content by weight of the emulsion. The emulsion might also contain trace amounts of volatile organic compounds such as xylene and/or toluene present as a result of the manufacturing process.

Silicone resins, which may be used in the emulsion of the oxidation protection system 100, include optionally crosslinked resins comprising units selected from the group consisting of Rx SiOy where x is 3, 2 or 1 and y is 0.5, 1.0 or 1.5 respectively, and where the R groups are phenyl, methyl, trifluoropropyl and/or vinyl. A typical number average molecular weight and weight average molecular weight of such resins are 420 and 2190, respectively. Preferred silicone resins include lightly crosslinked or soft phenylmethyl silicone resins and moderately to highly crosslinked or medium-hard phenylmethyl silicone resins. The most preferred silicone resin is medium-hard phenylmethyl silicone resin where an increase in the hardness and fluid resistance of the cured inventive coating composition has been observed when this moderately to highly crosslinked resin is used.

Embodiments herein utilize a metal pigment with the proper surfactant. In order to ensure the primary layer 106 provides the most robust corrosion protection a new surfactant is coupled to a new pigment to create a resin system able to provide the necessary properties. This coating formulation provides the desired oxidation protection and manufacturability for C/C composite structures.

In various embodiments, the surfactant is an ionic surfactant. For example, the surfactant can be a cationic surfactant. The surfactant can thus be an ammonium salt of polycarboxylic acid. A commercially available version of such a surfactant can be BYK-154 produced by BYK company and which is an ammonium polyacrylate-based dispersing additive for pigments 110.

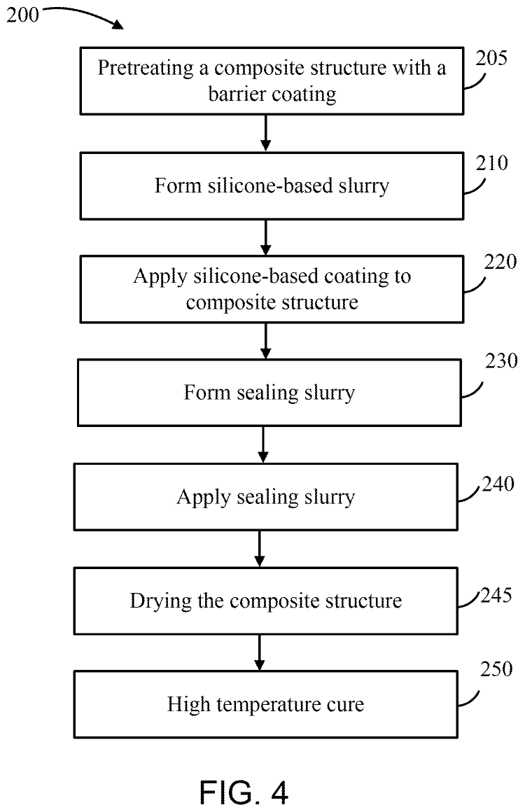

In various embodiments, a method for limiting an oxidation reaction in a substrate (e.g., a C/C composite structure) may comprise forming an oxidation protection system on the composite structure 102 from FIG. 2. With reference to FIG. 4, a method 200 for forming an oxidation protection system 100 on a composite structure 102 is illustrated. In accordance with various embodiments, method 200 may, for example, comprise applying an oxidation inhibiting composition to non-wear surfaces of C/C composite brake components, such as non-wear surfaces 45 and/or lugs 54. Non-wear surface 45, as labeled in FIG. 1, simply references an exemplary non-wear surface on a brake disk, but non-wear surfaces similar to non-wear surface 45 may be present on any brake disks (e.g., rotors 32, stators 34, pressure plate 36, end plate 38, or the like). In various embodiments, method 200 may be used on the back face of pressure plate 36 and/or end plate 38, an inner diameter (ID) surface of stators 34 including slots 56, as well as an outer diameter (OD) surface of rotors 32 including lugs 54. Method 200 may be performed on densified C/C composites. In this regard, method 200 may be performed after carbonization and densification of the C/C composite.

In various embodiments, method 200 may comprise forming a silicone-based slurry (step 210). The silicone-based slurry may be formed from 39.6 to 67.3% by weight of a phenylmethyl silicone resin emulsion having a total weight percent silicone resin solids content of approximately 48 to 72%; (ii) from 8.3 to 19.2% by weight of inhibited metal pigment (e.g., aluminum and/or silicon pigments) (iii) from 0.05 to 3.0% by weight of water soluble ionic surfactant; and (iv) from 10.5 to 52.0% by weight water, and has a total weight percent solids content of approximately 24.4 to 50.0%. In various embodiments, the metal pigments (e.g., the leafing (FIG. 3A) or non-leafing (FIG. 3B) pigments 110 can be configured for oxygen (O₂ gettering) during operation of the oxidation protection system 100 from FIG. 2, in accordance with various embodiments.

In various embodiments, the silicone-based slurry can further include antifoams, pH buffers, anti-rust agents, biocides, fungicides, antifreeze agents, etc. However, some such additives may have an adverse effect on the coating's durability, oxidation protection, coating properties and/or resistance to high temperatures.

In preparing the silicone-based slurry, water and surfactant are blended together and the surfactant is allowed to dissolve for at least thirty (30) minutes. The leafing pigment is then added to the resulting water solution. Dispersion of the filler material in the water solution is achieved by gentle agitation of the solution with a paddle to break apart the large agglomerates. This is followed by ensuring that the leafing pigment is completely covered by the water solution and allowing the filler material to fully disperse by soaking for approximately 24 to 72 hours. During this period, the dispersion is agitated at least twice per twenty four hour period. A letdown is then prepared by blending a silicone resin emulsion and water for approximately 15 to 20 minutes. The letdown is allowed to fully dissolve for approximately 24 to 72 hours. The dispersion is then added to the letdown and thoroughly blended. The resulting admixture is then allowed to fully disperse for at least 24 hours. As can be well understood by those skilled in the art, excessive stirring during preparation of the coating composition is to be avoided.

In accordance with various embodiments, method 200 further comprises applying the silicone-based slurry to a composite structure 102 (step 220). Applying the silicone-based slurry may comprise, for example, spraying or brushing the silicone-based slurry to an outer surface of the composite structure. Any suitable manner of applying the silicone-based slurry to the composite structure is within the scope of the present disclosure. As referenced herein, the composite structure may refer to a C/C composite structure. In accordance with various embodiments, the silicone-based slurry may be applied directly on (i.e., in physical contact with) the surface of the composite structure. In various embodiments, the silicone-based slurry applied in step 220 can be cured prior to applying the sealing slurry in step 230 (i.e., baked in an inert atmosphere to form microporous framework of a silicone-based coating). However, the present disclosure is not limited in this regard. For example, the silicone-based slurry can be cured with the sealing slurry from step 230 (e.g., in step 250), in accordance with various embodiments.

In various embodiments, method 200 may comprise forming a sealing slurry (step 230) by combining a silicon compound, a glass mixture, a silica glass former compound, and a glass modifier with a carrier fluid (such as, for example, water). In various embodiments, the silicon compound may comprise at least one silicon-comprising refractory material (e.g., ceramic material). In various embodiments, the silicon compound may comprise silicon carbide, a silicide compound, silicon, silicon dioxide, silicon carbonitride, or combinations thereof.

In various embodiments, the silicon slurry may comprise from about 5.0% to about 30.0% by weight silicon compound, from about 10.0% to about 20.0% by weight silicon compound, from about 9.0% to about 11.0% by weight silicon compound, or from about 18.0% to about 20.0% by weight silicon compound. As used in previous context only, the term “about” means ±1.0 weight percent. In various embodiments, the silicon slurry may comprise approximately 18.9% by weight silicon compound. As used in previous context only, the term “approximately” means ±0.50 weight percent. In various embodiments, the silicon slurry may comprise approximately 10.1% by weight silicon compound. As used in the previous context only, the term “approximately” means ±0.50 weight percent. In various embodiments, the silicon slurry may comprise approximately 18.8% by weight silicon compound. As used in the previous context only, the term “approximately” means ±0.50 weight percent.

In various embodiments, the silicon compound is a powder (e.g., silicon powder or silicon carbide powder). The silicon compound powder may comprise particles having an average particle size of between about 100 nm and 50 μm, between 500 nm and 20 μm, between 500 nm and 1.5 μm, or between 16 μm and 18 μm. As used in previous context only, the term “about” means ±1.0 μm. In various embodiments, the silicon compound may comprise particles having an average particle size of approximately 0.7 μm. As used in the previous context only, the term “about” means ±0.25 μm. In various embodiments, the silicon compound may comprise particles having an average particle size of approximately 1.0 μm. As used in the previous context only, the term “about” means ±0.25 μm.

The glass mixture of the sealing slurry comprises at least two glass compounds. For example, the glass mixture can comprise a first glass compound and a second glass compound. The first glass compound and the second glass compound can have different melting temperatures.

The glass mixture of the boron slurry may comprise at least two of the following glass compounds: a phosphate-based glass, an alkaline glass, a borosilicate glass, a silicate glass (e.g., a SiO₂ based glass), an SiON glass, and/or a high-temperature melting point glass as described further herein. In various embodiments, the glass mixture of the boron slurry comprises a phosphate-based glass and a borosilicate glass. In various embodiments, the glass mixture comprises a phosphate-based glass, a first borosilicate glass, and a second borosilicate glass.

In various embodiments, a first glass compound in the glass mixture can comprise a viscosity temperature profile that is different from a second glass compound. In various embodiments, a viscosity at a first temperature of a first glass compound of the glass mixture is less than a viscosity at the first temperature of a second glass compound of the glass mixture by orders of magnitude. For example, a first glass compound can have a viscosity of approximately 1.0×10⁵ Pa·S at 1,250° F. (677° C.) and a second glass compound can have a viscosity of approximately 1×10⁹ Pa·S at 1,250° F. (677° C.). Similarly, the first glass compound can have a viscosity that is order of magnitudes less than the second glass compound at a second temperature. For example, the first glass compound of the glass mixture can have a viscosity at 1,650° F. (899° C.) of approximately 3.2×10² Pa·S and the second glass compound can have a viscosity at 1,650° F. (899° C.) of approximately 3.0×10⁵ Pa·S.

In various embodiments, the first glass compound of the glass mixture includes a viscosity at 1,250° F. (677° C.) between 5.0×10⁴ Pa·S and 5.0×10⁵ Pa·S, or between 7.5×10⁴ Pa·S and 2.5×10⁵ Pa·S, or approximately 1.0×10⁵ Pa·S. In various embodiments, the first glass compound can have a viscosity at 1,650° F. (899° C.) between 8.2×10¹ Pa·S and 8.2×10² Pa·S, or between 0.7×10² Pa·S and 5.7×10⁵ Pa·S, or approximately 3.2×10² Pa·S.

In various embodiments, the second glass compound of the glass mixture includes a viscosity at 1,250° F. (677° C.) between 5.0×10⁸ Pa·S and 5.0×10⁹ Pa·S, or between 7.5×10⁸ Pa·S and 2.5×10⁹ Pa·S, or approximately 1.0×10⁹ Pa·S. In various embodiments, the second glass compound can have a viscosity at 1,650° F. (899° C.) between 8.0×10⁴ Pa·S and 8.0×10⁵ Pa·S, or between 0.5×10⁵ Pa·S and 5.5×10⁵ Pa·S, or approximately 3.0×10⁵ Pa·S.

In various embodiments, by having a first glass compound with a viscosity temperature profile with a significantly lower viscosity (i.e., at least two orders of magnitude) at various temperatures relative to a viscosity temperature profile of a second glass compound, a softening viscosity of a coating made from the glass mixture can be significantly broadened. For example, a softening viscosity of a coating made from the process described herein can be within the range of 1×10⁴ and 1×10⁹ Pa·S for a wide temperature range (e.g., between 1,000° F. (538° C.) and 1,800° F. (982° C.)) as described further herein.

In various embodiments, the glass mixture can comprise a third glass compound with a viscosity temperature profile that is between the first glass compound and the second glass compound. In various embodiments, the third glass compound of the glass mixture includes a viscosity at 1,250° F. (677° C.) between 8.1×10⁶ Pa·S and 8.1×10⁷ Pa·S, or between 0.6×10⁷ Pa·S and 5.6×10⁷ Pa·S, or approximately 3.1×10⁷ Pa·S. In various embodiments, the third glass compound can have a viscosity at 1,650° F. (899° C.) between 5.0×10⁴ Pa·S and 5.0×10⁵ Pa·S, or between 7.5×10⁴ Pa·S and 2.5×10⁵ Pa·S, or approximately 1.0×10⁵ Pa·S. In various embodiments, the third glass compound can comprise a viscosity of approximately 3.1×10⁷ Pa·S at 1,250° F. (677° C.) and a viscosity of approximately 1.0×10⁵ at 1,650° F. (899° C.).

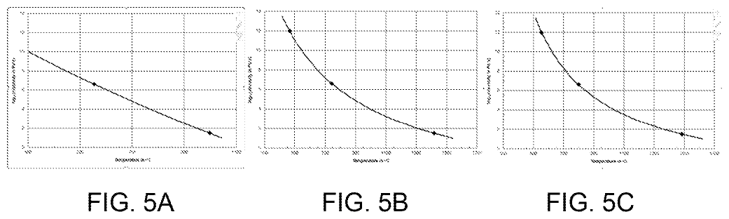

With brief reference to FIG. 5A-C, in various embodiments, the first glass compound can have a viscosity temperature profile in accordance with FIG. 5A, the second glass compound can have a viscosity temperature profile in accordance with FIG. 5C, and the third glass compound can have a viscosity temperature profile in accordance with FIG. 5B. Although described herein as comprising three glass compounds in the glass mixture, the present disclosure is not limited in this regard. For example, the glass mixture could include only two of the three glass compounds shown in FIGS. 5A-C, the glass mixture could include additional glass compounds, or the like.

In various embodiments, the first glass compound of the glass mixture comprises a phosphate-based glass. For example, the phosphate-based glass can comprise in mol percentage of the first glass compound, about 1.0% SiO₂, about 6.5% B₂O₃, about 0.8% Al₂O₃, about 12% MgO, about 3.5% BaO, about 20% Li₂O, about 0.1% F, and about 56% P₂O₅. As used in previous context only, the term “about” means ±1.0 mol percent. In various embodiments, the first glass compound may form approximately 20%±10 weight percent of the glass mixture.

In various embodiments, the second glass compound of the glass mixture comprises a first borosilicate glass. For example, the second glass compound can comprise, in mol percentage of the second glass compound, about 75% SiO₂, about 21% B₂O₃, about 2% Al₂O₃, and about 2% Na₂O. As used in previous context only, the term “about” means ±1.0 mol percent. In various embodiments, the second glass compound may form approximately 30%±10 weight percent of the glass mixture.

In various embodiments, the third glass compound of the glass mixture comprises a second borosilicate glass. For example, the third glass compound can comprise, in mol percentage of the third glass compound, about 61% SiO₂, about 27% B₂O₃, about 1% BaO, about 1% Li₂O, about 1% Na₂O, and about 0.5% K₂O. As used in previous context only, the term “about” means ±1.0 mol percent. In various embodiments, the second glass compound may form approximately 50%±20 weight percent of the glass mixture.

In various embodiments, a working point of the first glass compound is between 1450° F. (788° C.) and 1650° F. (899° C.), or approximately 1575° F. (857° C.). In various embodiments, a working point of the second glass compound is between 2,200° F. (1,204° C.) and 2,400° F. (1,316° C.), or approximately 2,285° F. (1,252° C.). In various embodiments, a working point of the third glass compound is between 1,950° F. (1,066° C.) and 2,150° F. (1,177° C.). “Working point” as referred to herein, is a temperature when a viscosity of the glass compound is 1.0×10³ Pa·S.

In various embodiments, the silica glass former may include colloidal silica, metal silicates, alkyl silicates, and/or elemental silica. In various embodiments, the silica glass former is a colloidal silica suspension having 40.0% by weight silica. In various embodiments, the silica glass former may be silicon powder. The silica glass former may form between about 10.0% and about 40.0%, between about 20.0% and about 30.0%, between about 22.0% and about 24.0%, or between about 24.0% and 26.0% of the weight percentage of the silicon slurry. As used the previous context only, the term “about” means ±1.0 weight percent. In various embodiments, the silica glass former may form approximately 22.7% of the weight percentage of the silicon slurry. As used the previous context only, the term “approximately” means ±0.5 weight percent. In various embodiments, the silica glass former may form approximately 25.2% of the weight percentage of the silicon slurry. As used the previous context only, the term “approximately” means ±0.5 weight percent. In various embodiments, the silica glass former may form approximately 22.5% of the weight percentage of the silicon slurry. As used the previous context only, the term “approximately” means ±0.5 weight percent.

In various embodiments, the silicon slurry may also comprise monoaluminium phosphate. The monoaluminium phosphate may be in the form of a solution (e.g., monoaluminium phosphate and a carrier fluid) of any suitable make-up. In various embodiments, the monoaluminium phosphate solution may comprise about 50% by weight monoaluminium phosphate and about 50% by weight carrier fluid (e.g., water). In the previous context only, the term “about” means ±10 weight percent. In various embodiments, the monoaluminium phosphate solution may form between about 1% and about 10%, between about 2% and about 5%, or between about 3% and about 4% of the weight percentage of the silicon slurry. As used the previous context only, the term “about” means ±1.0 weight percent. In various embodiments, the monoaluminium phosphate solution may form approximately 3.03% of the weight percentage of the silicon slurry. As used the previous context only, the term “approximately” means ±0.5 weight percent. In various embodiments, the monoaluminium phosphate solution may form approximately 3.36% of the weight percentage of the silicon slurry. As used the previous context only, the term “approximately” means ±0.5 weight percent.

In various embodiments, the silicon slurry may also comprise a glass modifier. The glass modifier may include an alkaline earth metal compound such as, for example, calcium boride (CaB₆), calcium oxide (CaO), calcium carbonate (Ca(CO₃)₂), magnesium boride (MgB₂), magnesium oxide (MgO), magnesium carbonate (Mg(CO₃)₂), a zirconium compound such as, for example, zirconium boride (ZrB₂), zirconium oxide (ZrO), zirconium carbonate (Zr(CO₃)₂), and/or an aluminum compound such as aluminum oxide (Al₂O₃). The glass modifier reacts with the borosilicate glass and refractory oxides that may form during oxidation, thereby resulting in a more stable and/or denser glass ceramic coating at associated temperature range. In various embodiments, the glass modifier may form between about 1.0% and about 15.0%, between about 3.0% and about 10.0%, or between about 5.0% and about 7.0% of the weight percentage of the silicon slurry. As used the previous context only, the term “about” means ±1.0 weight percent. In various embodiments, the glass modifier may form approximately 6.1% of the weight percentage of the silicon slurry. As used the previous context only, the term “approximately” means ±0.5 weight percent. In various embodiments, the glass modifier may form approximately 6.7% of the weight percentage of the silicon slurry. As used the previous context only, the term “approximately” means ±0.5 weight percent.

In various embodiments, the silicon slurry may comprise, in weight percentage, 18.94% silicon carbide powder, 22.73% borosilicate glass, 3.03% monoaluminium phosphate solution, 22.73% colloidal silica suspension, 6.06% zirconium boride, and 26.52% water. The borosilicate glass may comprise in weight percentage 13% B₂O₃, 61% SiO₂, 2% Al₂O₃, and 4% Na₂O, and may have a CTE of 3.3×10⁻⁶ cm/C, a working point of 2286° F. (1252° C.), and an annealing point of 1040° F. (560° C.). The colloidal silica suspension may be 40% by weight silica. The monoaluminium phosphate solution may be 50% by weight monoaluminium phosphate and 50% by weight carrier fluid.

In various embodiments, the silicon slurry may comprise, in weight percentage, 10.08% silicon carbide powder, 25.21% borosilicate glass, 3.36% monoaluminium phosphate solution, 25.21% colloidal silica suspension, 6.72% zirconium boride, and 29.41% water. The borosilicate glass may comprise in weight percentage 13% B₂O₃, 61% SiO₂, 2% Al₂O₃, and 4% Na₂O, and may have a CTE of 3.3×10⁻⁶ cm/C, a working point of 2286° F. (1252° C.), and an annealing point of 1040° F. (560° C.). The colloidal silica suspension may be 40% by weight silica. The monoaluminium phosphate solution may be 50% by weight monoaluminium phosphate and 50% by weight carrier fluid.

In various embodiments, the silicon slurry may comprise, in weight percentage, 18.80% silicon carbide powder, 22.56% borosilicate glass, 3.01% monoaluminium phosphate solution, 22.56% colloidal silica suspension, 6.77% zirconium boride, and 26.32% water. The borosilicate glass may comprise in weight percentage 13% B₂O₃, 61% SiO₂, 2% Al₂O₃, and 4% Na₂O, and may have a CTE of 3.3×10⁻⁶ cm/C, a working point of 2286° F. (1252° C.), and an annealing point of 1040° F. (560° C.). The colloidal silica suspension may be 40% by weight silica. The monoaluminium phosphate solution may be 50% by weight monoaluminium phosphate and 50% by weight carrier fluid.

In various embodiments, the sealing layer is configured to seal the microporous silica framework formed from the silicone-based coating in steps 220, 225. In various embodiments, the sealing layer 108 can sit on a thin barrier layer formed on the primary layer 106 (e.g., leafing layer 107 as shown in FIG. 3A).

In various embodiments, method 200 further comprises applying the sealing slurry to the composite structure (step 240). Applying the silicon slurry may comprise, for example, spraying or brushing the silicon slurry over the surface on which the boron slurry was applied (e.g., the silicon slurry is applied over the boron slurry). Any suitable manner of applying the silicon slurry to the composite structure is within the scope of the present disclosure. As referenced herein, the composite structure may refer to a C/C composite structure.

In various embodiments, method 200 may further comprise performing a high temperature cure (step 250) to form a primary layer 106 (e.g., comprising a microporous silica framework) on the composite structure 102 and a sealing-glass layer (e.g., sealing layer 108) on the primary layer 106. In this regard, the microporous Silica framework of the primary layer 106 can be penetrated by the sealing-glass layer (e.g., sealing layer 108), in accordance with various embodiments. Step 250 may include heating the composite structure at a relatively high temperature, for example, a temperature of between 1200° F. (649° C.) to about 2000° F. (1093° C.), between about 1500° F. (816° C.) to about 1700° F. (927° C.), or about 1650° F. (899° C.), wherein the term “about” in previous context only means ±25° F. (±14° C.)). Step 250 may include heating the composite structure for about 5 minutes to about 8 hours, about 30 minutes to about 5 hours, or about 2 hours, wherein the term “about” in this context only means ±10% of the associated value.

In various embodiments method 200, may further comprise applying at least one of a pretreating composition or a barrier coating (step 205) prior to applying the first slurry. Step 205 may, for example, comprise applying a first pretreating composition to an outer surface of a composite structure, such as a component of aircraft wheel brake assembly 10. In various embodiments, the first pretreating composition comprises an aluminum oxide in water. For example, the aluminum oxide may comprise an additive, such as a nanoparticle dispersion of aluminum oxide (for example, NanoBYK-3600® sold by BYK Additives & Instruments). The first pretreating composition may further comprise a surfactant or a wetting agent. The composite structure may be porous, allowing the pretreating composition to penetrate at least a portion of the pores of the composite structure.

In various embodiments, after applying the first pretreating composition, the component may be heated to remove water and fix the aluminum oxide in place. For example, the component may be heated between about 100° C. (212° F.) and 200° C. (392° F.), and further, between 100° C. (212° F.) and 150° C. (302° F.).

In various embodiments, the pretreatment composition may comprise monoaluminium phosphate. The monoaluminium phosphate may be in the form of a solution (e.g., monoaluminium phosphate and a carrier fluid) of any suitable make-up. In various embodiments, the monoaluminium phosphate solution may comprise about 50% by weight monoaluminium phosphate and about 50% by weight carrier fluid (e.g., water). In the previous context only, the term “about” means ±10 weight percent. In various embodiments, after applying the pretreatment composition, the composite structure is heated to remove carrier fluid and fix the monoaluminium phosphate over the composite structure. In accordance with various embodiments, method 300 may include applying the boron slurry (step 220) after heating the composite structure to remove the carrier fluid (e.g., water) of the pretreatment composition.

Step 205 may further comprise applying a second pretreating composition. In various embodiments, the second pretreating composition comprises a phosphoric acid and an aluminum phosphate, aluminum hydroxide, and/or aluminum oxide. The second pretreating composition may further comprise, for example, a second metal salt such as a magnesium salt. In various embodiments, the aluminum to phosphorus molar ratio of the aluminum phosphate is 1 to 3 or less by weight. Further, the second pretreating composition may also comprise a surfactant or a wetting agent. In various embodiments, the second pretreating composition is applied to the composite structure atop the first pretreating composition. The composite structure may then, for example, be heated. In various embodiments, the composite structure may be heated between about 600° C. (1112° F.) and about 800° C. (1472° F.), and further, between about 650° C. (1202° F.) and 750° C. (1382° F.).

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for forming an oxidation protection system on a carbon-carbon composite structure, comprising:
applying a silicone-based slurry to the carbon-carbon composite structure, the silicone-based slurry including metal pigments disposed therein;
applying a sealing slurry to the silicone-based slurry; and
heating the carbon-carbon composite structure.

2. The method of claim 1, wherein the sealing slurry comprises a silicon compound, a glass mixture, a glass former, a glass modifier, and a carrier fluid.

3. The method of claim 2, wherein the glass mixture including a first glass compound and a second glass compound, the first glass compound having a first viscosity-temperature profile that is at least two orders of magnitude below a second viscosity-temperature profile of the second glass compound.

4. The method of claim 1, wherein the metal pigments include at least one of aluminum, silicon, chromium, iron, copper, nickel, silver, and gold.

5. The method of claim 4, wherein the metal pigments includes at least one of aluminum and silicon.

6. The method of claim 1, wherein the metal pigments are between 1% and 20% by weight of the silicone-based slurry.

7. The method of claim 1, wherein the metal pigments include a median diameter range between 0.5 μm and 70 μm.

8. The method of claim 1, wherein the metal pigments are leafing pigments, and wherein in response to solvents in the silicone-based slurry evaporating, convection currents push the metal pigments to a surface of a silicone-based coating formed from the silicone-based slurry from the heating of the carbon-carbon composite structure.

9. The method of claim 1, wherein the metal pigments are non-leafing pigments, and wherein in response to the heating of the carbon-carbon composite structure, the non-leafing pigments are distributed throughout a silicone-based coating formed from the silicone-based slurry.

10. A carbon-carbon composite component, comprising:
a composite structure;
an oxidation protection system disposed on the composite structure, the oxidation protection system including:
a primary layer coupled to the composite structure, the primary layer including a silicone-based coating with metal pigments; and
a sealing layer coupled to the primary layer, the sealing layer configured to penetrate a microporous framework of the primary layer.

11. The carbon-carbon composite component of claim 10, wherein the metal pigments comprise leafing metal pigments.

12. The carbon-carbon composite component of claim 11, wherein the leafing metal pigments form a leafing layer between the primary layer and the sealing layer.

13. The carbon-carbon composite component of claim 10, wherein the metal pigments comprise non-leafing metal pigments distributed throughout the silicone-based coating.

14. The carbon-carbon composite component of claim 10, wherein the metal pigments include a median diameter range between 0.5 μm and 70 μm.

15. The carbon-carbon composite component of claim 10, wherein the metal pigments are between 1% and 20% by weight of the silicone-based coating.

16. The carbon-carbon composite component of claim 10, wherein the metal pigments comprise at least one of aluminum, silicon, chromium, iron, copper, nickel, silver, and gold.

17. An oxidation protection system for a carbon-carbon composite structure, the oxidation protection system comprising:
a silicone-based coating configured to couple to the carbon-carbon composite structure, the silicone-based coating including metal pigments; and
a sealing layer configured to couple to the silicone-based coating, the sealing layer configured to penetrate a microporous framework formed from the silicone-based coating, the sealing layer formed from a glass mixture including a first glass compound and a second glass compound, the first glass compound having a first viscosity-temperature profile that is at least two orders of magnitude below a second viscosity-temperature profile of the second glass compound.

18. The oxidation protection system of claim 17, wherein the metal pigments are leafing metal pigments, and wherein, the leafing metal pigments form a leafing layer between the silicone-based coating and the sealing layer.

19. The oxidation protection system of claim 17, wherein the metal pigments are non-leafing metal pigments, and wherein the metal pigments are distributed throughout the silicone-based coating.

20. The oxidation protection system of claim 17, wherein the metal pigments comprise at least one of aluminum, silicon, chromium, iron, copper, nickel, silver, and gold.
